(19) United States
(12) Patent Application Publication
(10) Pub. No.: US 2012/0087447 A1
(43) Pub. Date: Apr. 12, 2012

(54) APPARATUS AND METHOD FOR ESTIMATING HIGH SPEED FREQUENCY OFFSET IN WIRELESS COMMUNICATION SYSTEM

(75) Inventors: Yon-Woo Yoon, Anyang-si (KR); Hee-Won Kang, Seongnam-si (KR)

(73) Assignee: SAMSUNG ELECTRONICS CO., LTD., Suwon-si (KR)

(21) Appl. No.: 13/249,039

(22) Filed: Sep. 29, 2011

(30) Foreign Application Priority Data
Oct. 7, 2010 (KR) 10-2010-0097664

(51) Int. Cl. H04L 27/06

(52) U.S. Cl. 375/343

(57) ABSTRACT

An apparatus and method estimate a high speed frequency offset in a wireless communication system. The apparatus includes a correlator, an accumulator, a phase calculator, and a frequency offset coupler. The correlator performs a first correlation and a second correlation based on a first reference signal and a second reference signal. The accumulator accumulates results of the correlations. The phase calculator calculates a first phase and a second phase from the accumulated first correlation value and the accumulated second correlation value. The frequency offset coupler determines whether a frequency offset deviates from a frequency offset estimate range based on a difference between the first phase and the second phase, and compensates the frequency offset according to the determination result. The apparatus can estimate a frequency offset within an error allowable range under an environment where a terminal moves at high speed.

### CROSS-REFERENCE TO RELATED APPLICATION(S) AND CLAIM OF PRIORITY

The present application is related to and claims the benefit under 35 U.S.C. §119 to a Korean patent application filed in the Korean Intellectual Property Office on Oct. 7, 2010 and assigned Serial No. 10-2010-0097664, the contents of which is herein incorporated by reference.

### TECHNICAL FIELD OF THE INVENTION

The present invention relates to frequency offset estimation in a wireless communication system. More particularly, the present invention relates to an apparatus and a method for estimating an accurate frequency offset under an environment where a terminal moves at high speed in a wireless communication system.

### BACKGROUND OF THE INVENTION

Because an Orthogonal Frequency Division Multiplexing (OFDM)/Orthogonal Frequency Division Multiple Access (OFDMA) system supports use efficiency and a transmission rate of a high frequency band, it is one of various multiplexing systems that are currently used widely.

The OFDM/OFDMA system is very sensitive to a frequency offset, and more particularly, when a frequency offset exists, it is difficult to maintain orthogonality between subcarriers and so its performance deteriorates substantially. Therefore, a step for estimating a frequency offset is very important in an OFDM system.

Meanwhile, a subcarrier frequency offset between transceivers and a Doppler frequency generated by movement velocity of a terminal make channel estimation difficult due to a channel change depending on time. It is possible to improve a channel estimation performance by estimating the frequency offset and compensating for the same before channel estimation. In an OFDM system where a pilot pattern exists inside a tile structure, a frequency offset is generally estimated from a phase difference of a pilot signal. Regarding the estimated frequency offset, an estimable range is determined depending on a symbol spacing between two pilot signals whose phase difference is measured.

A pilot pattern in an Institute of Electrical and Electronics Engineers (IEEE) 802.16m system is separated by three symbols or more at the minimum, such that a frequency offset of a terminal that moves at a high speed of 200 Km/h or more cannot be accurately estimated.

The terminal synchronizes a carrier frequency offset with a base station within a range allowed by the system via a ranging process. When the carrier frequency offset is synchronized within 2% of a subcarrier spacing (for example, 10.937 kHz), a maximum subcarrier frequency offset is 218.74 Hz. In addition, when a center frequency is 2.5 GHz and a terminal moves at a velocity of 350 Km/h, a maximum Doppler frequency is defined by Equation 1 below.

$${f}_{D} = \frac{{f}_{C}}{c} v \frac{2.5 \times {10}^{9}}{3.00 \times {10}^{8}} \times \frac{350}{3.6} = 810.2 Hz \qquad [ Eqn . 1 ]$$

When a terminal estimates a frequency offset via a downlink and then synchronizes a center frequency by the frequency offset and transmits the same, a frequency offset of a base station modem occurs by double of a maximum Doppler frequency. Therefore, a range of a frequency offset that may be generated by a carrier frequency offset and a Doppler frequency becomes −1839.2˜1839.2 Hz.

A range that can be estimated using a pilot signal of a Physical Resource Unit (PRU) is determined based on a symbol spacing by which a pilot pair of the same subcarrier is separated from a time axis. Though a spacing of pilot symbols is different depending on a type of a PRU, and so a range of a frequency offset that can be estimated is different depending on a subframe type, the pilot pair is separated by three symbols or more at the minimum, such that a maximum estimate range is just −1620˜1620 Hz. In all situations, an estimation range does not reach a frequency offset occurrence maximum range (−1839.2˜1839.2 Hz). In other words, it is impossible to accurately estimate a frequency offset of a terminal moving at a high speed by only using a pilot signal.

Therefore, there is a need for an apparatus and a method for estimating an accurate frequency offset under an environment where a terminal moves at a high speed in an OFDM/OFDMA-based wireless communication system.

### SUMMARY OF THE INVENTION

To address the above-discussed deficiencies of the prior art, it is a primary aspect of the present invention to solve at least the above-mentioned problems and/or disadvantages and to provide at least the advantages described below. Accordingly, an aspect of the present invention is to provide an apparatus and a method for estimating a frequency offset under an environment where a terminal moves at a high speed in a wireless communication system.

Another aspect of the present invention is to provide an apparatus and a method for improving a system performance by accurately measuring a frequency offset of a terminal moving at a high speed in a wireless communication system.

In accordance with an aspect of the present invention, an apparatus for estimating a high speed frequency offset in a wireless communication system is provided. The apparatus includes at least one correlator, at least one accumulator, at least one phase calculator, and a frequency offset coupler. The at least one correlator performs a first correlation and a second correlation based on a first reference signal and a second reference signal. The at least one accumulator for accumulates results of the first correlation and results of the second correlation. the at least one phase calculator calculates a first phase and a second phase from the accumulated first correlation value and the accumulated second correlation value. The frequency offset coupler determines whether a frequency offset deviates from a frequency offset estimate range based on a difference between the first phase and the second phase, and compensates the frequency offset according to the determination result.

In accordance with another aspect of the present invention, a method for estimating a high speed frequency offset in a wireless communication system is provided. A first correlation and a second correlation are performed based on a first reference signal and a second reference signal. Results of the first correlation and results of the second correlation are accumulated. A first phase and a second phase are calculated from the accumulated first correlation value and the accumulated second correlation value. It is determined as to whether a frequency offset deviates from a frequency offset estimate range based on a difference between the first phase and the second phase. And the frequency offset is compensated according to the determination result.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning, and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of an apparatus for estimating a frequency offset under an environment where a terminal moves at high speed in a wireless communication system according to an embodiment of the present invention;

FIG. 2 illustrates a process for estimating a frequency offset under an environment where a terminal moves at high speed in a wireless communication system according to an embodiment of the present invention;

FIG. 3 is a view of a pilot pattern in a CRU 1Tx stream according to an embodiment of the present invention;

FIG. 4 is a view illustrating PFBCH including three 2×6 UL FMT according to an embodiment of the present invention;

FIG. 5 is a view illustrating correlation of a PFBCH signal according to an embodiment of the present invention; and

FIG. 6 is a performance graph according to an embodiment of the present invention.

### DETAILED DESCRIPTION OF THE INVENTION

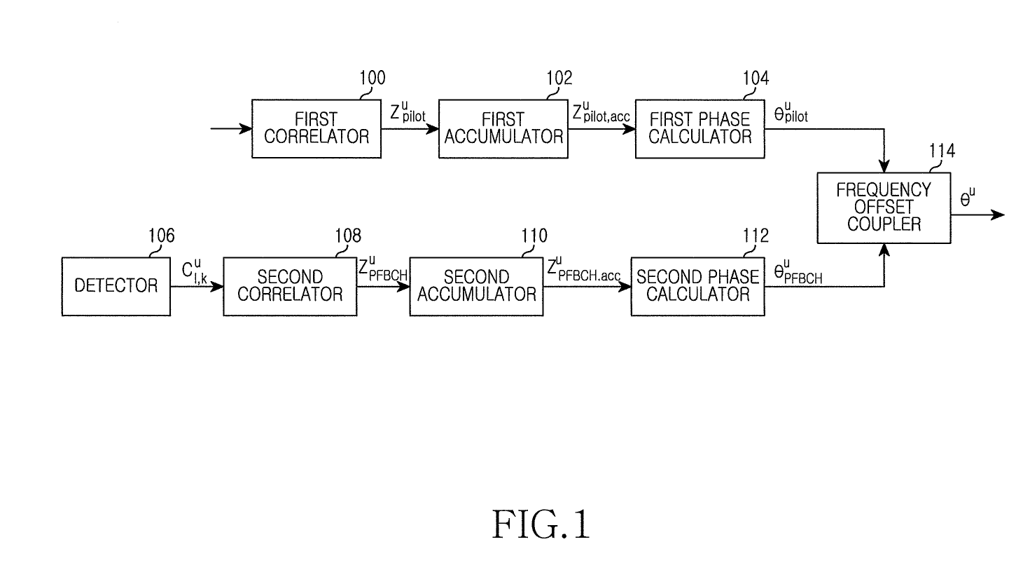

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

Preferred embodiments of the present invention will be described with reference to the accompanying drawings. In the following description, well-known functions or constructions are not described in detail since they would obscure the invention in unnecessary detail. Terms described below, which are defined considering functions in the present invention, may be different depending on user and operator's intention or practice. Therefore, the tennis should be defined on the basis of the disclosure throughout this specification.

Embodiments of the present invention provide an apparatus and a method for estimating a frequency offset under an environment where a terminal moves at a high speed in a wireless communication system. More particularly, embodiments of the present invention provide a technique for estimating a frequency offset of a terminal that moves at a high speed using a Primary Fast Feedback Channel (PFBCH), which is one of uplink control channels of IEEE 802.16m.

Though embodiments of the present invention are described based on an IEEE 802.16m system, they are applicable to other wireless communication systems based on the OFDM/OFDMA.

In addition, though embodiments of the present invention are described using an example of estimating a frequency offset by receiving a pilot signal and a PFBCH sequence transmitted from a terminal to a base station, a frequency offset may be estimated by receiving a pilot signal and a different sequence transmitted from a base station to a terminal.

FIG. 1 is a block diagram of an apparatus for estimating a frequency offset under an environment where a terminal moves at a high speed in a wireless communication system according to an embodiment of the present invention.

Referring to FIG. 1, the apparatus for estimating a frequency offset includes a first correlator 100, a first accumulator 102, a first phase calculator 104, a detector 106, a second correlator 108, a second accumulator 110, a second phase calculator 112, and a frequency offset coupler 114.

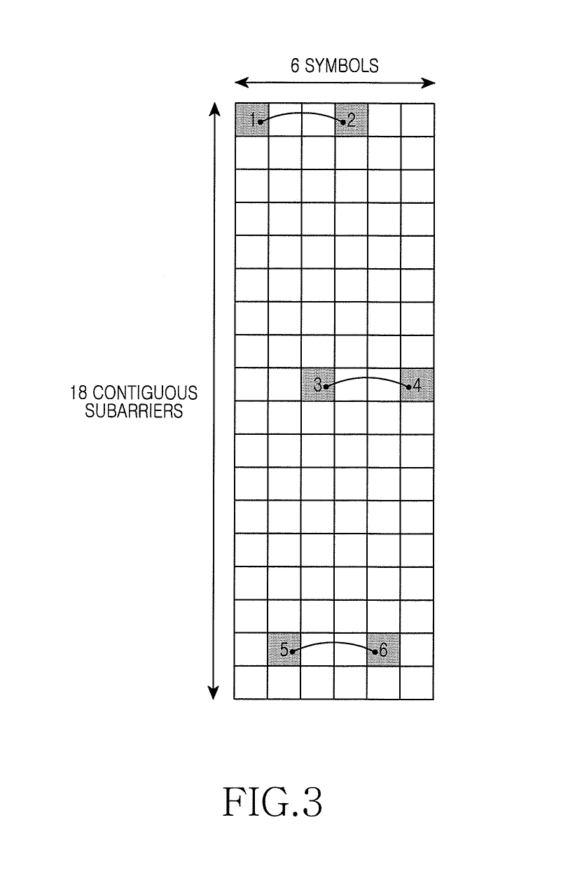

The first correlator 100 estimates a frequency offset from a phase difference by a time difference of a pilot signal. More particularly, all Physical Resource Units (PRUs) allocated to terminals estimate a frequency offset using a pilot signal of a stream corresponding to each terminal. Assuming that Least-Squares (LS) channel estimation of a pilot tone received from a terminal via a reception antenna r is Ĥ^{r}_{LS}[lᵢ^{p}, kᵢ^{p}], correlation of a pilot signal in the same subcarrier is given by Equation 2.

$${Z}_{pilot}^{r , n} = {\sum }_{n = 1}^{\begin{matrix}\begin{matrix}u \text{-} th \\ {user}^{′} s\end{matrix} \\ PRU\end{matrix}} {\sum }_{l = 1}^{{N}_{p} 12} {\hat{H}}_{LS}^{n , r} [ {l}_{2 l }^{p} , {k}_{2 l}^{p} ] {( {\hat{H}}_{LS}^{n , r} [ {l}_{LS}^{n , r} , {k}_{2 l - 1}^{p} ] )}^{*} \qquad [ Eqn . 2 ]$$

where N is the number of PRUs allocated to a terminal u, and Np is the number of pilot tones included in a PRU. An example of estimating a channel using a pilot signal is described with reference to a pilot pattern example at a Contiguous Resource Unit (CRU) 1Tx stream of FIG. 3.

When a Carrier to Interference Ratio (CINR) is low, the first accumulator 102 accumulates correlator outputs Zₚᵢₗₒₜ^{r,u} from the first correlator 100 in order to improve the accuracy of a frequency offset estimate. An accumulated result Z_{pilot.acc}^{r,u}(t₁) of Zₚᵢₗₒₜ^{r,u} is given by Equation 3.

Z_{pilot.acc}^{r,u}(t₁)=(1−β₁)·Z_{pilot.acc}^{r,u}(t₁−1)+β₁·Zₚᵢₗₒₜ^{r,u} [Eqn. 3]

That is, the first accumulator 102 may reflect a frequency offset change depending on time via weighted sum.

The first phase calculator 104 calculates a first phase using Equation 4 from an output signal from the first accumulator 102. The first phase is a phase using a pilot signal and is updated every subframe or every frame.

$${θ}_{pilot}^{r , u} = \frac{∠ {Z}_{pilot . acc}^{r , u}}{Δ l} \qquad [ Eqn . 4 ]$$

where Δl is a pilot symbol spacing.

The detector 106 detects a sequence (referred to as a PFBCH sequence) transmitted via a PFBCH.

A PFBCH of a terminal that moves at a high speed deteriorates in its detection performance due to a Doppler frequency. When a frequency offset is estimated using a PFBCH sequence that has a detection error, an estimation value that is substantially different from an actual frequency offset is obtained. When a frequency offset is estimated using the PFBCH, the detection performance of the PFBCH has a great influence on a frequency offset estimate performance. Therefore, for estimating a frequency offset of a terminal that moves at a high speed, a PFBCH detector that has a high detection performance even at high speeds is used.

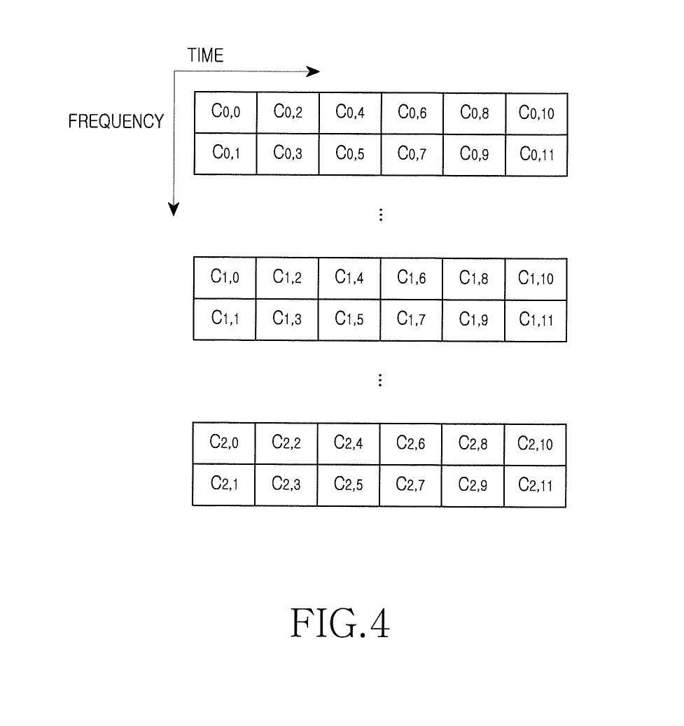

Generally, a PFBCH sequence is allocated in a frequency axis and a time axis according to FIG. 4. However, to improve PFBCH sequence (Ct, k) detection performance under an environment where a terminal moves at a high speed, an embodiment of the present invention extends a PFBCH sequence set and uses the same for detection. An extended PFBCH sequence is defined by Equation 5.

$${C}_{t , k}^{( s )} = {C}_{t , k} exp [ - j 2 π ⌊ \frac{k}{2} ⌋ s {ɛ}_{MA X} ] \qquad [ Eqn . 5 ]$$

where k is a PFBCH sequence index, 0≦k≦11, and t is a Feedback Mini Tile (FMT) index. s is an extended PFBCH sequence set index, and has a value of (−1, 0, 1). ε_{MAX} is a normalized frequency offset of an extended PFBCH sequence set, and is a variable determining a frequency offset region that the extended PFBCH sequence intends to improve.

Therefore, the conventional 64 PFBCH sequences may be extended to 192 PFBCH sequences based on Equation 5. Therefore, when 192 extended PFBCH sequences are detected, it is possible to detect a PFBCH sequence of a terminal that moves at high speed of 350 Km/h.

The second correlator 108 receives relevant PFBCH index information from the detector 106 and uses a sequence element corresponding to the relevant PFBCH index as a virtual pilot to estimate a frequency offset. That is, a signal correlation result of PFBCH is given by Equation 6.

$${Z}_{PFBCH}^{″} = {\sum }_{k = 0}^{6} {\sum }_{l = 1}^{5} {{Y}_{l , k}^{u , r} ( {C}_{l , k}^{u} )}^{*} {( {Y}_{l - 1 , k}^{u , r} )}^{*} {C}_{l - 1 , k}^{u} \qquad [ Eqn . 6 ]$$

where k is a subcarrier index, 1 is a symbol index, Y_{l,k}^{u,r} is a received PFBCH sequence, and C_{l,k}^{u,r} is a PFBCH sequence corresponding to a relevant PFBCH index.

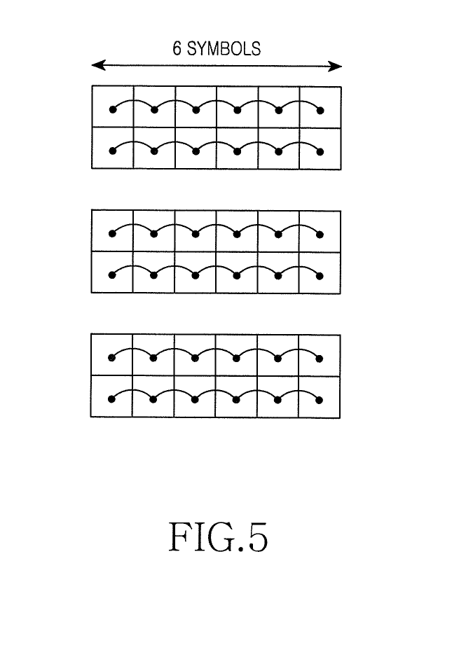

As illustrated in FIG. 5, since a frequency offset is estimated using right contiguous signals via a PFBCH, a frequency offset estimate range is much wider than when estimating a frequency offset using a pilot signal.

When a CINR is low, the second accumulator 110 accumulates correlator outputs Z_{PFBCH}^{r,u} from the second correlator 108 in order to raise a frequency offset estimate accuracy. An accumulated result Z_{PFBCH.acc}^{r,u}(t₂) of Z_{PFBCH}^{r,u} is given by Equation 7.

Z_{PFBCH.acc}^{r,u}(t₂)=(1−β₂)·Z_{PFBCH.acc}^{r,u}(t₂−1)+β₂·Z_{RCH}^{r,u} [Eqn. 7]

That is, the second accumulator 110 may reflect a frequency offset change depending on time via weighted sum.

The second phase calculator 112 calculates a second phase using Equation 8 from an output signal from the second accumulator 110. The second phase is a phase obtained using a PFBCH, and is periodically transmitted and updated at a period longer than that of pilot signal transmission.

θ_{PFBCH}^{r,u}=∠Z_{PFBCH.acc}^{r,u} [Eqn. 8]

The frequency offset coupler 114 determines whether a frequency offset deviates from a frequency offset estimate range using a first phase θₚᵢₗₒₜ^{u} from the first phase calculator 104 and a second phase θ_{PFBCH}^{u} from the second phase calculator 112, and determines a frequency offset according to a result thereof.

Here, a determination equation for determining whether a frequency offset deviates from the frequency offset estimate range using a difference between the first phase and the second phase is given by Equation 9.

$${v}^{r , u} = round ( ( {θ}_{PFBCH}^{r , u} - {θ}_{pilot}^{r , u} ) \frac{Δ l}{2 π} ) \qquad [ Eqn . 9 ]$$

where =v^{r,u} indicating whether a frequency offset deviates from a frequency offset estimate range has a value of −1, 0, 1, round ( ) is a rounding off function, and Δl is a pilot symbol spacing.

For example, when v^{r,u} is “1”, it indicates that the frequency offset estimate range deviates in a direction of +90 degree, when v^{r,u} is “−1”, it indicates that the frequency offset estimate range deviates in a direction of −90 degree, and when v^{r,u} is “0”, it indicates that a frequency offset exists within the frequency offset estimate range.

Therefore, a final frequency offset from the frequency offset coupler 114 is given by Equation 10.

$${θ}_{freq}^{r , u} = {θ}_{pilot}^{r , u} + {v}^{r , u} \frac{2 π}{Δ l} \qquad [ Eqn . 10 ]$$

A phase θₚᵢₗₒₜ^{r,u} using a pilot signal is updated every subframe/frame, but a frequency offset range that can be estimated is limited. Therefore, according to Equation 10, θₚᵢₗₒₜ^{r,u} is compensated for using a phase θ_{PFBCH}^{r,u} obtained using PFBCH. That is, when v^{r,u} is “0”, a frequency offset exists within the frequency offset estimate range, such that a frequency offset is determined using θₚᵢₗₒₜ^{r,u}. When v^{r,u} is ±1, a frequency offset deviates from the frequency offset estimate range, such that the frequency offset is determined by compensating for θₚᵢₗₒₜ^{r,u}.

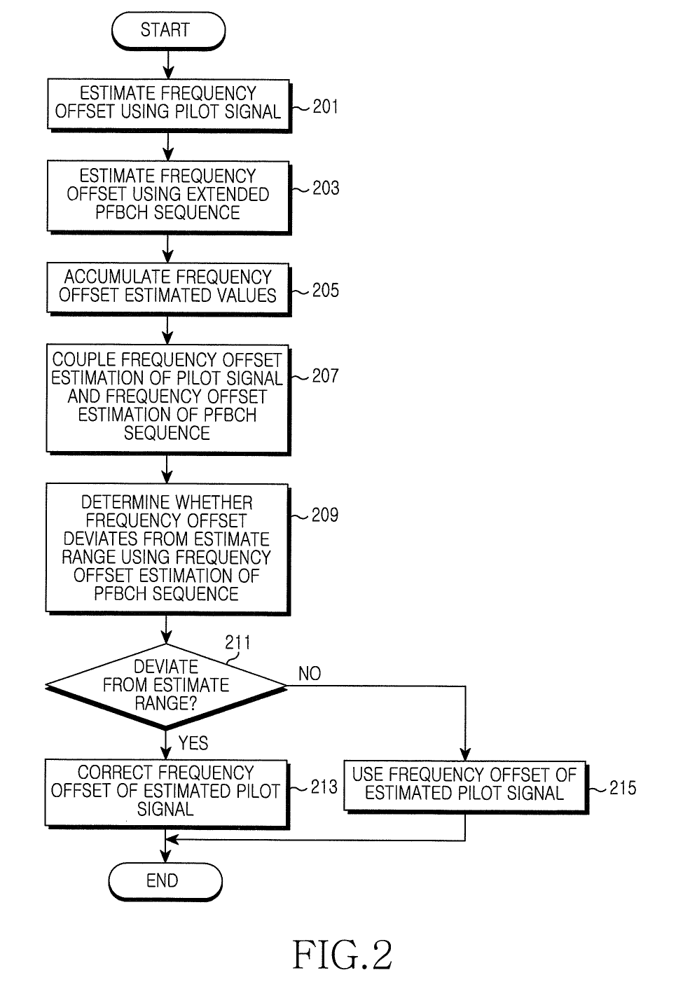

FIG. 2 illustrates a process for estimating a frequency offset under an environment where a terminal moves at a high speed in a wireless communication system according to an embodiment of the present invention.

Referring to FIG. 2, the first correlator 100 performs correlation of a pilot signal in order to estimate a frequency offset in step 201. More particularly, all PRUs allocated to terminals estimate a frequency offset using a pilot signal of a stream corresponding to each terminal.

The second correlator 108 performs correlation for frequency offset estimation using a PFBCH sequence detected by the detector 106 in step 203. When 64 PFBCH sequences are used, a detection performance is deteriorated due to a Doppler frequency. Therefore, an embodiment of the present invention extends a PFBCH sequence set and uses the same for detection in order to improve a PFBCH sequence (Ct, k) detection performance under an environment where a terminal moves at a high speed. The extended PFBCH sequence is given by Equation 5.

That is, the second correlator 108 receives relevant PFBCH index information from the detector 106 and performs correlation using a sequence element corresponding to the relevant PFBCH index as a virtual pilot. That is, a signal correlation result of a PFBCH is given by Equation 6.

Step 201 and step 203 may be performed independently in parallel, or one of steps may be performed and then the other step may be performed.

When a CINR is low, the accumulators 102 and 110 accumulate correlator outputs Zₚᵢₗₒₜ^{r,u} and Z_{PFBCH}^{r,u} in order to raise a frequency offset estimate accuracy in step 205.

The phase calculators 104 and 112 calculate a first phase and a second phase from output signals from the accumulators 102 and 110 in step 205. The first phase is a phase using a pilot signal and is updated every subframe or every frame. The second phase is a phase obtained using a PFBCH, and is periodically transmitted and updated at a period longer than that of pilot signal transmission.

The frequency offset coupler 114 determines whether a frequency offset deviates from a frequency offset estimate range using a first phase θₚᵢₗₒₜ^{u} and a second phase θ_{PFBCH}^{u} from the phase calculators 104 and 112 in step 209. Here, a determination equation for determining whether a frequency offset deviates from the frequency offset estimate range using a difference between the first phase and the second phase is given by Equation 9. For example, depending on the determination result, it is known that whether the frequency offset estimate range deviates in a direction of +90 degrees, whether the frequency offset estimate range deviates in a direction of −90 degrees, or whether the frequency offset exists within the frequency offset estimate range.

When the frequency offset deviates from the estimate range in step 211, the frequency offset coupler 114 proceeds to step 213 to compensate for a phase of an estimated pilot signal and estimate the frequency offset.

In contrast, when the frequency offset does not deviate from the frequency offset range, the frequency offset coupler 114 proceeds to step 215 to directly use the phase of the estimated pilot signal to determine the frequency offset. A final frequency offset is defined by Equation 10.

FIG. 3 is a view of a pilot pattern in a CRU 1Tx stream according to an embodiment of the present invention.

Referring to FIG. 3, one CRU includes eighteen successive subcarriers and six OFDM symbols. Six pilot tones exist inside one CRU.

Therefore, when correlation is performed using a pilot signal, correlation is performed on a pilot tone of the same subcarrier. For example, correlation is performed on pilot tones of the same subcarrier, such as a first pilot tone and a second pilot tone, a third pilot tone and a fourth pilot tone, and a fifth pilot tone and a sixth pilot tone.

FIG. 4 is a view of a PFBCH including three 2×6 UL FMT according to an embodiment of the present invention.

Referring to FIG. 4, in C_{l,k}, ‘l’ is an FMT index, and k is a PFBCH sequence index.

FIG. 5 is a view illustrating correlation of a PFBCH signal according to an embodiment of the present invention.

Referring to FIG. 5, a frequency offset may be estimated by using a sequence element corresponding to a relevant PFBCH index as a virtual pilot and performing correlation between right contiguous signals.

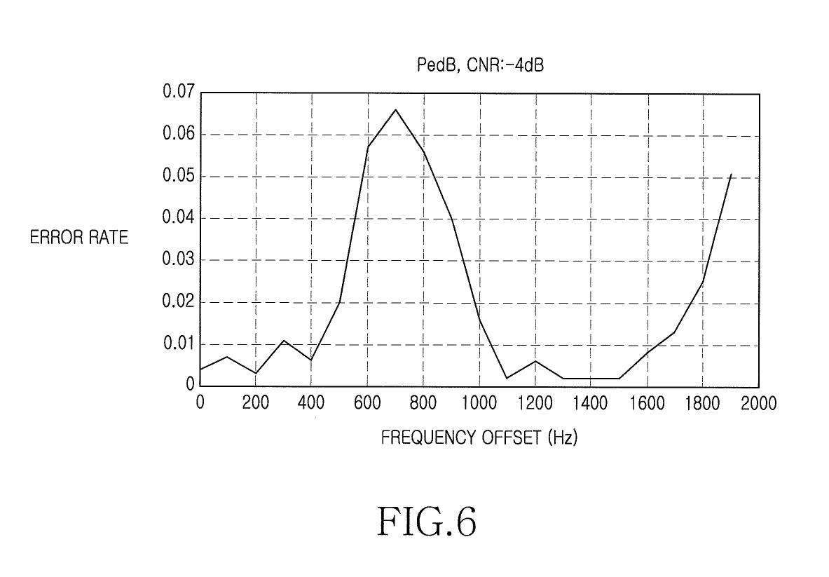

FIG. 6 is a performance graph according to an embodiment of the present invention.

Referring to FIG. 6, a graph showing a performance depending on a frequency offset when detection is performed using an extended PFBCH sequence is illustrated.

In the graph, x-axis is a frequency offset value and y-axis is an error rate depending on a frequency offset.

The performance graph reveals that an error of 7% or less is met over an entire frequency offset range.

As described above, an embodiment of the present invention determines a frequency offset using a pilot signal where a frequency offset estimate range is limited but accurate estimation is possible, and a PFBCH sequence whose frequency offset estimate range is wide but which is transmitted at a long period. That is, an embodiment of the present invention determines whether the frequency offset deviates from the estimate range, and a direction to which the frequency offset deviates if the frequency offset deviates using the PFBCH, and compensates for the estimated frequency offset using a pilot signal.

As described above, an embodiment of the present invention has an advantage of estimating a frequency offset within an error allowable range under an environment where a terminal moves at a high speed by determining a frequency offset estimate range using a phase estimated via a PFBCH sequence, and then compensating for a phase of a pilot signal depending on the result thereof to determine the frequency offset.

Although the invention has been shown and described with reference to certain embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. An apparatus for estimating a high speed frequency offset in a wireless communication system, the apparatus comprising:
at least one correlator configured to perform a first correlation and a second correlation based on a first reference signal and a second reference signal;
at least one accumulator configured to accumulate results of the first correlation and results of the second correlation;
at least one phase calculator configured to calculate a first phase and a second phase from the accumulated first correlation value and the accumulated second correlation value; and
a frequency offset coupler configured to determine whether a frequency offset deviates from a frequency offset estimate range based on a difference between the first phase and the second phase, and compensate the frequency offset according to the determination result.

2. The apparatus of claim 1, wherein the first reference signal comprises a pilot signal having a pilot pattern inside a resource unit, and the second reference signal comprises a sequence signal transmitted via a Primary Fast Feedback Channel (PFBCH).

3. The apparatus of claim 2, wherein the PFBCH is transmitted at a period longer than that of the pilot signal.

4. The apparatus of claim 2, wherein a frequency offset estimate range by the second reference signal is wider than a frequency offset estimate range by the first reference signal.

5. The apparatus of claim 1, further comprising a detector configured to detect a sequence forming the second reference signal.

6. The apparatus of claim 1, wherein a sequence forming the second reference signal is extended to phases of +90 degrees, −90 degrees, and 0 degree.

7. The apparatus of claim 6, wherein the extended sequence is determined using the equation below:
$${C}_{t , k}^{( s )} = {C}_{t , k} exp [ - j 2 π ⌊ \frac{k}{2} ⌋ s {ɛ}_{M A X} ]$$
where k is a PFBCH sequence index, 0≦k≦11, t is a Feedback Mini Tile (FMT) index, s is an extended PFBCH sequence set index having a value of (−1, 0, 1), and ε_{MAX} is a normalized frequency offset of an extended PFBCH sequence set and is a variable determining a frequency offset region that the extended PFBCH sequence intends to improve.

8. The apparatus of claim 1, wherein the frequency offset coupler is further configured to determine whether the frequency offset deviates from the frequency offset estimate range based on the equation below:
$${v}^{r , u} = round ( ( {θ}_{PFBCH}^{r , u} - {θ}_{pilot}^{r , u} ) \frac{Δ l}{2 π} )$$
where v^{r,u} indicating whether the frequency offset deviates from the frequency offset estimate range has a value of (−1, 0, 1), round ( ) is a rounding off function, Δl is a pilot symbol spacing, θₚᵢₗₒₜ^{r,u} is a phase of the first reference signal, and θ_{PFBCH}^{r,u} is a phase of the second reference signal.

9. The apparatus of claim 1, wherein the frequency offset coupler is further configured to compensate a phase of the first reference signal to determine the frequency offset when the frequency offset deviates from the frequency offset estimate range, and determine the frequency offset based on a phase of the first reference signal when the frequency offset does not deviate from the frequency offset estimate range.

10. The apparatus of claim 1, wherein the frequency offset coupler is further configured to determine the frequency offset using the equation below:
$${θ}_{freq}^{r , u} = {θ}_{pilot}^{r , u} + {v}^{r , u} \frac{2 π}{Δ l}$$
where v^{r,u} is a value indicating whether a frequency offset deviates from a frequency offset estimate range and has a value of (−1, 0, 1), Δl is a symbol spacing, θₚᵢₗₒₜ^{r,u} is a phase of the first reference signal, and θ_{PFBCH}^{r,u} is a phase of the second reference signal.

11. A method for estimating a high speed frequency offset in a wireless communication system, the method comprising:
performing a first correlation and a second correlation based on a first reference signal and a second reference signal;
accumulating results of the first correlation and results of the second correlation;
calculating a first phase and a second phase from the accumulated first correlation value and the accumulated second correlation value;
determining whether a frequency offset deviates from a frequency offset estimate range based on a difference between the first phase and the second phase; and
compensating the frequency offset according to the determination result.

12. The method of claim 11, wherein the first reference signal comprises a pilot signal having a pilot pattern inside a resource unit, and the second reference signal comprises a sequence signal transmitted via a Primary Fast Feedback Channel (PFBCH).

13. The method of claim 12, wherein the PFBCH is transmitted at a period longer than that of the pilot signal.

14. The method of claim 12, wherein a frequency offset estimate range by the second reference signal is wider than a frequency offset estimate range by the first reference signal.

15. The method of claim 11, further comprising detecting a sequence forming the second reference signal.

16. The method of claim 11, wherein a sequence forming the second reference signal is extended to phases of +90 degrees, −90 degrees, and 0 degree.

17. The method of claim 16, wherein the extended sequence is determined using the equation below:
$${C}_{t , k}^{( s )} = {C}_{t , k} exp [ - j 2 π ⌊ \frac{k}{2} ⌋ s {ɛ}_{MA X} ]$$
where k is a PFBCH sequence index, 0≦k≦11, t is a Feedback Mini Tile (FMT) index, s is an extended PFBCH sequence set index having a value of (−1, 0, 1), and ε_{MAX} is a normalized frequency offset of an extended PFBCH sequence set and is a variable determining a frequency offset region that the extended PFBCH sequence intends to improve.

18. The method of claim 11, wherein the determining of whether the frequency offset deviates from the frequency offset estimate range is performed based on the equation below:
$${v}^{r , u} = round ( ( {θ}_{PFBCH}^{r , u -} - {θ}_{pilot}^{r , u} ) \frac{Δ l}{2 π} )$$
where v^{r,u} indicating whether a frequency offset deviates from a frequency offset estimate range has a value of (−1, 0, 1), round ( ) is a rounding off function, Δl is a pilot symbol spacing, θₚᵢₗₒₜ^{r,u} is a phase of the first reference signal, and θ_{PFBCH}^{r,u} is a phase of the second reference signal.

19. The method of claim 11, wherein the compensating of the frequency offset comprises:
compensating a phase of the first reference signal to determine the frequency offset when the frequency offset deviates from the frequency offset estimate range; and
determining the frequency offset based on a phase of the first reference signal when the frequency offset does not deviate from the frequency offset estimate range.

20. The method of claim 11, wherein the compensating of the frequency offset is performed based on the equation below:
$${θ}_{freq}^{r , u} = {θ}_{pilot}^{r , u} + {v}^{r , u} \frac{2 π}{Δ l}$$
where v^{r,u} is a value indicating whether a frequency offset deviates from a frequency offset estimate range and has a value of (−1, 0, 1), Δl is a symbol spacing. θₚᵢₗₒₜ^{r,u} is a phase of the first reference signal, and θ_{PFBCH}^{r,u} is a phase of the second reference signal.
